(19) United States
(12) Patent Application Publication
(10) Pub. No.: US 2010/0119004 A1
(43) Pub. Date: May 13, 2010

(54) MIMO COMMUNICATION SYSTEM AND METHOD FOR DIVERSITY MODE SELECTION

(76) Inventor: Zion Hadad, Rishon Lezion (IL)

Correspondence Address: NIXON & VANDERHYE, PC, 901 NORTH GLEBE ROAD, 11TH FLOOR, ARLINGTON, VA, 22203, US

(21) Appl. No.: 12/522,232

(22) PCT Filed: Jan. 3, 2008
(86) PCT No.: PCT/IL2008/000021

§ 371 Date: Nov. 24, 2009

(30) Foreign Application Priority Data
Jan. 4, 2007 (IL) 180537

(51) Int. Cl. H04B 7/02

(52) U.S. Cl. 375/267

(57) ABSTRACT

In a MIMO communication system, a method for mode selection comprising: a. measuring communication variables including SNR, Correlation, Interference and Mobility; b. automatic change of mode, according to predefined criteria and responsive to the measured communication variables. The modes from which the selection is made include Spatial Multiplexing, Beamforming, Space-Time Coding and Beamforming.

### CROSS-REFERENCE TO RELATED APPLICATIONS

The present application claims priority from the patent application filed in Israel by the present applicant, application No. 180537 filed on 4 Jan. 2007.

### FIELD OF THE INVENTION

This invention relates to mode selection in MIMO systems.

### BACKGROUND OF THE INVENTION

At present, multiple-access multiple-input multiple-output (MIMO) communication systems gain acceptance as a means to increase channel capacity without increasing bandwidth. That is, both the transmitter and receiver each uses several antennas in the communication channel.

In the last few years there has been a growing interest in MIMO communications systems accommodating multiple transmit (Tx) and receive (Rx) antennae.

This interest originated from information theoretic results suggesting that the capacity of a communications system endowed with N Tx and N Rx antennae is up to N times the capacity of a SISO system. In a world continuously seeking to increase the capacity of radio channels, this result has made great impact.

In should be noted that this theoretical result (N times the capacity) refers to the case where the spatial channels are uncorrelated. When correlation does exit, the capacity may decrease.

Modes of operation in MIMO systems include:

a. Diversity Schemes

In diversity schemes the concept is to transmit the same signal over multiple channels and to combine at the receiver. This concept leads to superior channel condition (compared with the SISO case).

This idea may be easily understood, since when one of the channels is in fade, it does not imply the same for the others, so the link is affected to a lesser extent.

Such schemes are Rx diversity with Maximal Ratio Combining (MRC), and the Space-Time-Coding (STC) Alamouti scheme. The improved channel condition due to the diversity scheme may be followed by the application of higher modulation/coding rate to increase the throughput.

b. Capacity Schemes

Another approach is to increase the throughput, simply by transmitting independent data (streams) via different antennae. In contrast to diversity schemes, here we transmit multiple independent data over multiple channels.

For instance, if we have 2 Tx antenna and we transmit 2 different streams (1 from each antenna), we may separate them with a receiver accommodating 2 Rx antenna (or more) with adequate signal processing algorithms.

Such a scheme is the Spatial Multiplexing (SM) method. In general, the optimal decoding algorithm for SM is a NP hard problem (much more complex than that for diversity schemes). Thus, various suboptimal methods exist, each with a different complexity-performance tradeoff.

c. Beamforming (Fixed and Adaptive)

Beamforming is a method in which the in/out signals at the receive/transmit antennae are multiplied with a complex weights vector, thus creating a directional antenna. At the receiver, beamforming may be used to maximize the signal to noise ratio (SNR) of a desired user and/or to null out, or reduce, interference.

At the transmitter, beamforming may be used to maximize the SNR of a certain receiving user and/or avoid interfering with other, specific receivers. The steering weights may be fixed (they belong to a certain pre-determined set), or change adaptively according to the instantaneous channels conditions (Adaptive Beamfoming).

Obviously, the system may apply N different weight vectors to facilitate N different transceivers simultaneously (similar to SM, with the enhancement of interference rejection).

d. Closed-Loop MIMO

In Closed-Loop (CL) MIMO, the transmitter performs Tx Beamforming based on channel information feedback from the receiver. This information allows the transmitter to transmit the signals in a way that, ideally, is best for the receiver.

The receiver may feed back a quantized version of the channels matrix of the Singular-Vectors of this matrix obtained through the Singular-Value-Decomposition (SVD) procedure (which implies more processing at the receiver).

Practical implementation of a MIMO system is a complex process, it being difficult to choose a mode best suited for a specific transmitter and receiver, in various environments, for time-varying channels.

In prior art, the subscriber usually has two antennas, to allow for better reception. The base station (BS) will decide how to send, and in which MIMO mode. The BS decision may be responsive to reports from the mobile subscriber, indicating what is the capacity it can receive. Modes of MIMO include diversity and capacity, as detailed above.

### SUMMARY OF THE INVENTION

According to the present invention, a MIMO system uses automatic mode selection. The increased flexibility afforded by two or more antennas at the subscriber may be advantageously utilized to improve communication performance in a MIMO environment.

According to one aspect of the present invention, a MIMO system and method includes means for automatic change of modes, according to predefined criteria. The subscriber may include two or more antennas.

According to another aspect of the invention, the subscriber/mobile includes a measuring unit with means for measuring communication variables, such as SNR, Correlation, Interference and Mobility.

The measuring unit may also be incorporated into the BS.

According to yet another aspect of the invention, the Base Station (BS) includes means for selecting a mode of operation responsive to the above measured communication variables.

The mode selection may be done at the BS, as in other modes (outside of MIMO).

According to yet another aspect of the invention, a combination of the above mentioned modes may be applied, in an optimal manner to enhance the system performance. These include a combination of Spatial Multiplexing and Beamforming, or Space-Time-Coding and Beamforming. The incorporation of Beamforming together with MIMO techniques depends of the system capabilities. Such capabilities are the transmission of Sounding waveforms and so on.

The above may be implemented as a combination of beamforming and spatial multiplexing. Actually, we should further note that other combinations of mode should be selected. Among these are mode of combined diversity-capacity (as STC with rate >1), SM combined with Tx beamforming and so on.

### BRIEF DESCRIPTION OF THE DRAWINGS

FIG. 1 illustrates a MIMO communication system

FIG. 2 details a MIMO system with a BS directional transmit pattern

FIG. 3 details a MIMO system with a subscriber directional receive pattern

FIG. 4 details a MIMO system with cancellation of an interfering BS

FIG. 5 details the structure and operation of a subscriber MIMO system

FIG. 6 details the method of operation of a subscriber MIMO system

### DETAILED DESCRIPTION OF THE PREFERRED EMBODIMENTS

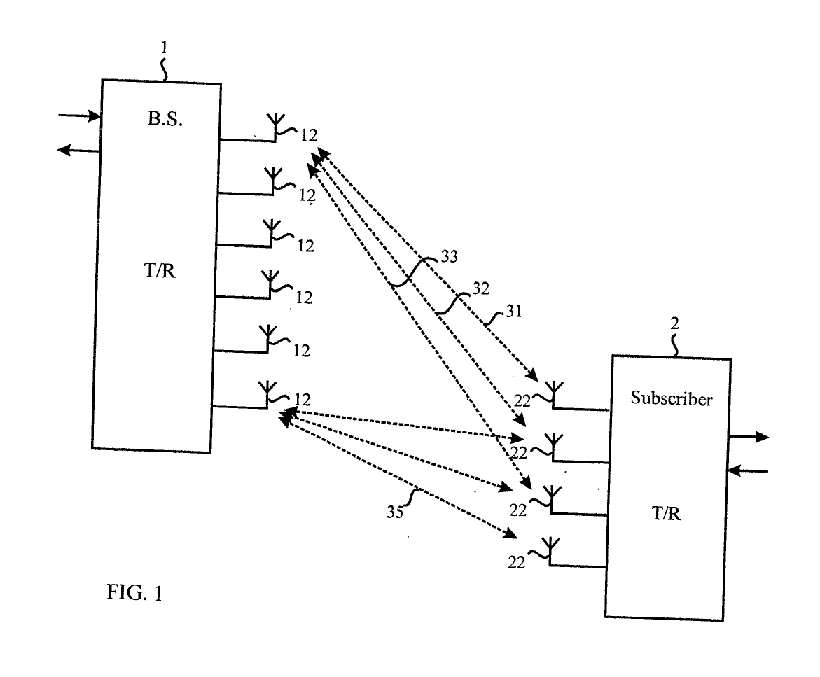

FIG. 1 illustrates a MIMO communication system, including a base station (BS) 1 with BS antennas 12, and a subscriber system 2 with subscriber system antennas 22. There may be spatial MIMO channels 31, 32, 33, 35 . . . between the BS 1 and subscriber 2.

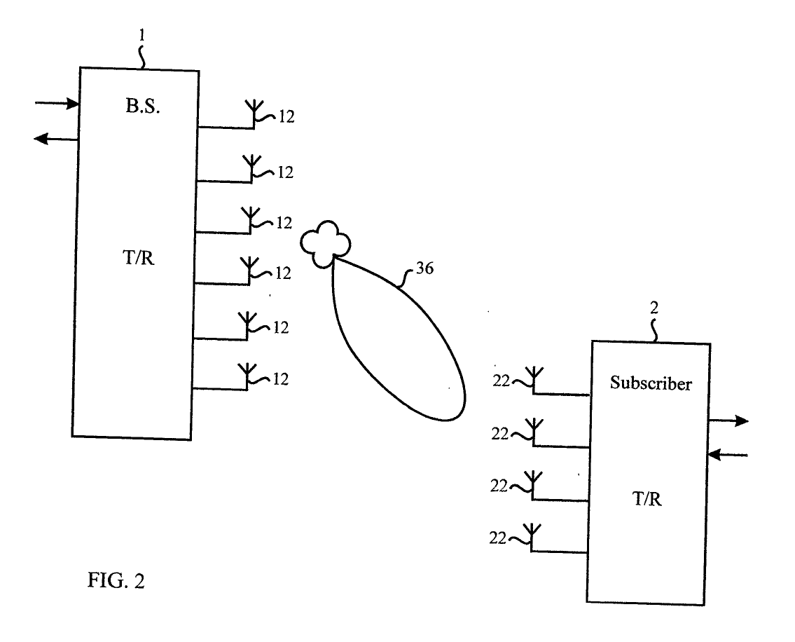

FIG. 2 details a MIMO system with a BS directional transmit pattern. The BS antennas 12 may be used to form a directional BS beam 36. Such a directional beam may be used to transmit from, and/or receive at, the base station. The beam 36 may be directed toward a subscriber system 2 it is desired to communicate therewith.

One of the possible scenarios that we are aiming at in the case of BF+MIMO is the creation of multiple beams to the multiple antennae at the receiver. Thus, to both increase the link condition and transmit multiple independent streams.

A directional beam of gain G will increase the channel gain by that factor, to overcome noise and interference and to allow a higher communication rate, as the need be.

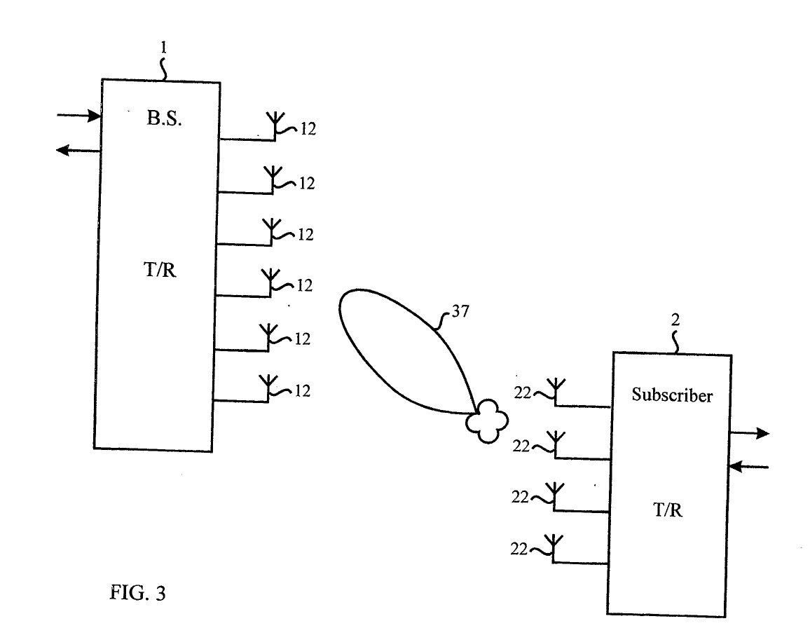

FIG. 3 details a MIMO system with subscriber system antennas 22 in the subscriber system 2 forming a subscriber directional receive pattern directional BS beam 37.

Such a directional beam may be used to transmit from, and/or receive at, the subscriber 2. The beam 37 may be directed toward a base station (BS) 1 it is desired to communicate therewith.

The most important aspect in this type of Beamforming (whether 1 or 2 spatial steams are used) is the method invoked for the creation of antennae weights for each of the spatial streams.

The weights may be calculated using the reciprocity property of wireless channels or by means of closed-loop MIMO. In reciprocity methods, the UT transmits Sounding waveforms which allow the Base-Station to estimate the channels matrices. The Beamforming weights may then be constructed using Maximal-Ratio-Transmission or other methods. In closed-loop MIMO, the weight vectors are transmitted by the UT. The Base-Station then uses these weights for Beamforming to the user.

Moreover, the number of spatial streams to be transmitted is a function of the instantaneous (of statistical) channels correlation. In the case of low channels correlation, it would be advantageous to transmit multiple streams. By contrast, in the case of high channels correlation, the optimal transmission strategy would be the transmission of single stream beamformed with the eigen-vector corresponding to the largest singular value of the channels matrix (eigen-beamforming).

The details in the above four paragraphs are more adequate to a line-of-sight scenario and are not well suited to the NLOS case that MIMO OFDM deals with.

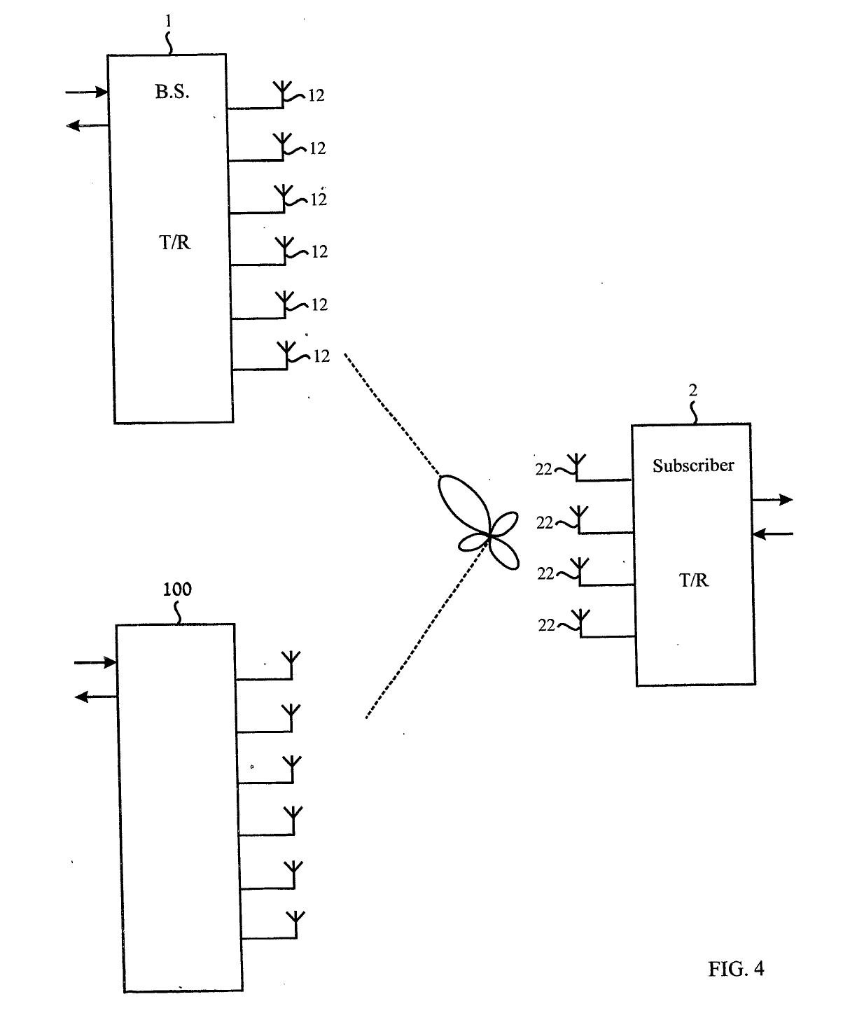

Using a large enough number of antennas 22, see FIG. 4, may facilitate improved performance, possibly canceling an interfering BS 100 while simultaneously increasing the gain towards another BS 1 which it is desired to communicate therewith. This possibility depends both on the number of the antennas 22 and their location with respect to the base station.

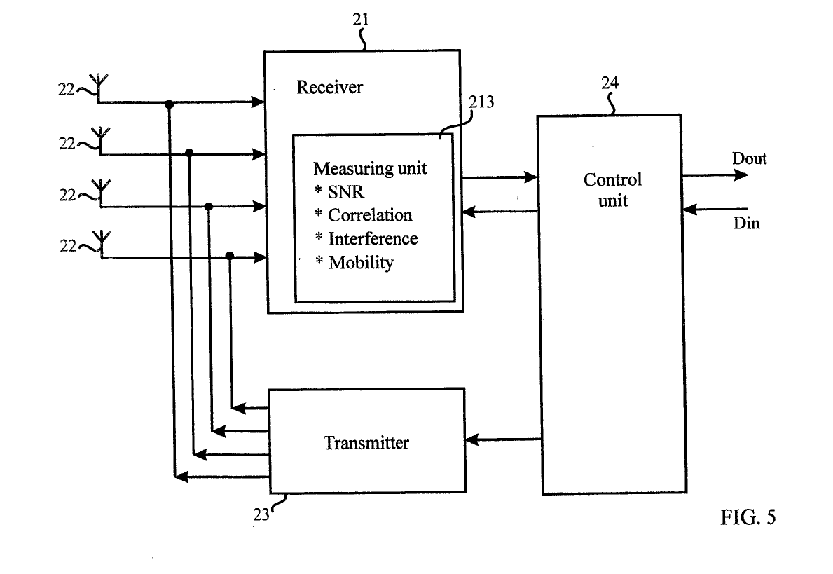

FIG. 5 details the structure and operation of a subscriber MIMO system. Received signals from a plurality of antennas 22 are processed in receiver means 21, which include beamforming means and a measuring unit 213.

Beamforming means (not shown) may multiply the received signals with complex weights prior to summing, to generate a directional beam and/or to cancel interfering signals. In another mode, the signals are not summed but processed to reconstruct several transmitted streams.

The measuring unit 213 may include means for measuring in real time communication variables, such as SNR, Correlation, Interference and Mobility.

Correlation between the received signals is indicative of the possibility and extent of using the Capacity mode to increase channel capacity, but also for diversity mode.

Interference may refer to an interfering BS 100, another subscriber nearby and/or another source of radio transmissions or radio-frequency noise.

Mobility may be measured directly as the subscriber's velocity, or indirectly as the rate of change of channel characteristics. The latter method may be preferable, for it also takes into account terrain characteristics, various structures such as buildings which may obstruct the channel or cause interference, etc.

The control unit 24 may process the received signals and the outputs of the measuring unit 213, to decide on the MIMO mode of operation according to a predefined algorithm.

This may also include cooperation and coordination with the BS, through the receiver 21 and transmitter 23.

The transmitter 23 is also connected to the antennas 22, and can effect various beam patterns, to enhance channel gain and/or to transmit several streams, etc., according to control signals from control unit 24.

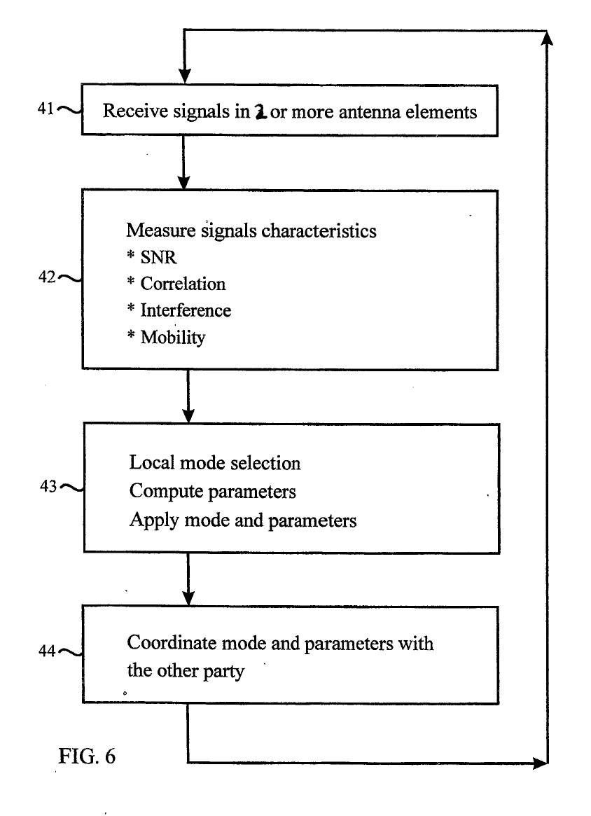

FIG. 6 details the method of operation of a subscriber MIMO system.

A method for performing automatic mode selection in a MIMO system includes:

a. Receive signals in 2 or more antenna elements [41]

b. Measure signals characteristics [42]

* SNR

* Correlation

* Interference

* Mobility

c. Automatic mode ‘selection [43], including:

Local mode selection

Compute parameters

Apply mode and parameters

d. Coordinate mode and parameters with the other party [44]

e. Repeat steps (a) to (d) in real time.

End of method.

Of special importance in the above method is the method of Mode Selection in MIMO OFDM using predefined criteria and responsive to channel condition.

The fact the numerous modes and methods exist, may already imply that the problem of selecting an operation mode is not trivial, it depends strongly on the link condition. In fact, simulation results and some analytical study show that none of the above-mentioned methods is superior to the others for all regimes.

Method for automatic MIMO mode and parameters selection)

The following method illustrates the effect of different parameters on each MIMO mode.

a. SNR

Preferably, SM should be used at good (above 10 dB) SNR. Otherwise, the diversity schemes (mainly STC) is superior, contingent on the application of adaptive modulation and coding Other threshold value may be used, according to the desired modulation.

The modulation method may be set according to the measured SNR value, including for example either QPSK or 16 QAM.

At low values of SNR—preferably use diversity, rather than capacity mode.

Directional beams may also be used at low SNR values.

b. Channels Correlation

SM is affected by channels correlation significantly more than STC, and CL-MIMO. The application of SM is advantageous at lower channels correlation.

c. Non-White Interference

In the presence of non-white interference (especially from other transmitters) an advantageous method is beamforming aimed at nulling the interfering signals. Interference will significantly degrade the performance of other methods.

Interference cancellation may also be used with white noise interference of various bandwidth, using techniques known in the art for that purpose.

d. Mobility

The application of CL-MIMO should preferably be considered at low or no mobility, since the feedback is on a Frame-to-Frame basis. In case of subscriber mobility, the channel information feedback based on previous frame may be outdated when applied at the transmitter.

e. Feasibility of beamforming for directionality and/or cancellation purposes: depending on instantaneous relative location and orientation between a subscriber and various desired/undesired other locations, beamforming may be easily implemented, implemented at a marginal benefit or may be impossible.

f. The above factors may change rapidly with time. A real time system measures these factors and changes the mode of operation as practical at any given moment.

End of method.

It will be recognized that the foregoing is but one example of an apparatus and method within the scope of the present invention, and that various modifications will occur to those skilled in the art upon reading the disclosure set forth hereinbefore.

1. In a MIMO Communication System, a method for mode selection comprising:
a. measuring communication variables including SNR, Correlation, Interference and Mobility;
b. automatic change of mode, according to predefined criteria and responsive to the measured communication variables.

2. The method for mode selection according to claim 1, wherein the modes from which the selection is made include Spatial Multiplexing, Beamforming, Space-Time-Coding and Beamforming.

3. The method for mode selection according to claim 1, wherein a combination of the modes is applied, including a combination of Spatial Multiplexing and Beamforming, or Space-Time-Coding and Beamforming.

4. The method for mode selection according to claim 2, wherein incorporating Beamforming together with MIMO techniques where the system capabilities allow it.

5. The method for mode selection according to claim 4, wherein system capabilities include a transmission of Sounding waveforms.

6. The method for mode selection according to claim 2, wherein a mode or a combination of modes is/are so selected as to enhance the system performance.

7. A method for performing automatic mode selection in a MIMO system comprising:
a. Receive signals in 2 or more antenna elements;
b. Measure signals characteristics;
c. Automatic mode selection so as to enhance the system performance;
d. Coordinate mode and parameters with the other party;
e. Repeat steps (a) to (d) in real time.

8. The method for performing automatic mode selection according to claim 7, measured signals characteristics include SNR, Correlation, Interference and/or Mobility.

9. The method for performing automatic mode selection according to claim 7, wherein the Automatic mode selection includes:
a. Local mode selection
b. Compute parameters
c. Apply mode and parameters.

10. In a MIMO system, automatic mode selection means comprising a measuring unit with means for measuring communication variables, and mode changing means according to predefined criteria and responsive to signals from the measuring unit.

11. The automatic mode selection means according to claim 10, wherein the means for measuring communication variables include SNR, Correlation, Interference and/or Mobility.

12. The automatic mode selection means according to claim 10, wherein the means for measuring communication variables is installed in the subscriber/mobile units.

13. The automatic mode selection means according to claim 10, wherein the means for measuring communication variables is installed in the base stations.

14. The automatic mode selection means according to claim 10, wherein the modes from which the selection is made include Spatial Multiplexing, Beamforming, Space-Time-Coding and Beamforming.

15. The automatic mode selection means according to claim 10, wherein a combination of the modes is applied, including a combination of Spatial Multiplexing and Beamforming, or Space-Time-Coding and Beamforming.

16. The automatic mode selection means according to claim 10, wherein incorporating Beamforming together with MIMO techniques where the system capabilities allow it.

17. The method for mode selection according to claim 16, wherein system capabilities include a transmission of Sounding waveforms.

18. The method for mode selection according to claim 10, wherein a mode or a combination of modes is/are so selected as to enhance the system performance.

19. The method for mode selection according to claim 10, wherein the Automatic mode selection includes:
a. Local mode selection
b. Compute parameters
c. Apply mode and parameters.
